(19) United States
(12) Patent Application Publication
(10) Pub. No.: US 2025/0104437 A1
(43) Pub. Date: Mar. 27, 2025

(54) WELLSITE OPERATIONS PPE MACHINE VISION FRAMEWORK

(71) Applicant: Schlumberger Technology Corporation, Sugar Land, TX (US)

(72) Inventors: Antonio Massoni Abinader, Houston, TX (US); Vigneshwaran Santhalingam, Houston, TX (US); Tammy Lam, Houston, TX (US); Dhananjaya Krishna, Sugar Land, TX (US); Velizar Vesselinov, Los Altos Hills, CA (US); Aniket Ulhasrao Joshi, Pune (IN)

(21) Appl. No.: 18/891,546

(22) Filed: Sep. 20, 2024

Related U.S. Application Data
(60) Provisional application No. 63/584,199, filed on Sep. 21, 2023.
(60) Provisional application No. 63/557,806, filed on Feb. 26, 2024.

(51) Int. Cl. G06V 20/52; G06Q 10/0631; G06V 10/764; G06V 20/64; G06V 40/10

(52) U.S. Cl. CPC G06V 20/52; G06Q 10/06311; G06V 10/764; G06V 20/64; G06V 40/103

(57) ABSTRACT

A method may include receiving imagery data from a wellsite; analyzing the imagery data for detection personal protective equipment; determining a risk to a human at the wellsite based on the analyzing; and, responsive to the determining, issuing an instruction to reduce the risk.

### RELATED APPLICATIONS

This application claims priority to and the benefit of a US Provisional Application having Ser. No. 63/584,199, filed 21 Sep. 2023, which is incorporated by reference herein in its entirety, and claims priority to and the benefit of a US Provisional Application having Ser. No. 63/557,806, filed 26 Feb. 2024, which is incorporated by reference herein in its entirety.

### BACKGROUND

A resource field may be an accumulation, pool or group of pools of one or more resources (e.g., oil, gas, oil and gas) in a subsurface environment. A resource field may include at least one reservoir. A reservoir may be shaped in a manner that may trap hydrocarbons and may be covered by an impermeable or sealing rock. A bore may be drilled into an environment where the bore may be utilized to form a well that may be utilized in producing hydrocarbons from a reservoir.

A rig may be a system of components that may be operated to form a bore in an environment, to transport equipment into and out of a bore in an environment, etc. As an example, a rig may include a system that may be used to drill a bore and to acquire information about an environment, about drilling, etc. A resource field may be an onshore field, an offshore field or an on- and offshore field. A rig may include components for performing operations onshore and/or offshore. A rig may be, for example, vessel-based, offshore platform-based, onshore, etc.

Field planning may occur over one or more phases, which may include an exploration phase that aims to identify and assess an environment (e.g., a prospect, a play, etc.), which may include drilling of one or more bores (e.g., one or more exploratory wells, etc.). Other phases may include appraisal, development and production phases.

### SUMMARY

A method may include receiving imagery data from a wellsite; analyzing the imagery data for detection personal protective equipment; determining a risk to a human at the wellsite based on the analyzing; and, responsive to the determining, issuing an instruction to reduce the risk. A system may include a processor; memory accessible by the processor; processor-executable instructions stored in the memory and executable to instruct the system to: receive imagery data from a wellsite; analyze the imagery data for detection of personal protective equipment; make a determination as to a risk to a human at the wellsite based on the analyzing; and, responsive to the determination, issuing an instruction to reduce the risk. One or more computer-readable storage media may include processor-executable instructions to instruct a computing system to: receive imagery data from a wellsite; analyze the imagery data for detection of personal protective equipment; make a determination as to a risk to a human at the wellsite based on the analyzing; and, responsive to the determination, issuing an instruction to reduce the risk. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations may be more readily understood by reference to the following description taken in conjunction with the accompanying drawings.

FIG. 1 illustrates examples of equipment in a geologic environment;

FIG. 2 illustrates examples of equipment and examples of hole types;

FIG. 3 illustrates examples of equipment at a wellsite;

FIG. 4 illustrates examples of equipment at a wellsite;

FIG. 5 illustrates an example of a system;

FIG. 6 illustrates an example of a method;

FIG. 7 illustrates an example of a system;

FIG. 8 illustrates an example of a system;

FIG. 9 illustrates an example of a visualization;

FIG. 10 illustrates an example of a system;

FIG. 11 illustrates an example of a graphic as to some examples of personal protective equipment;

FIG. 12 illustrates examples of components of an example of a framework;

FIG. 13 illustrates an example of a system;

FIG. 14 illustrates an example of a method and an example of a system; and

FIG. 15 illustrates an example of computing system.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

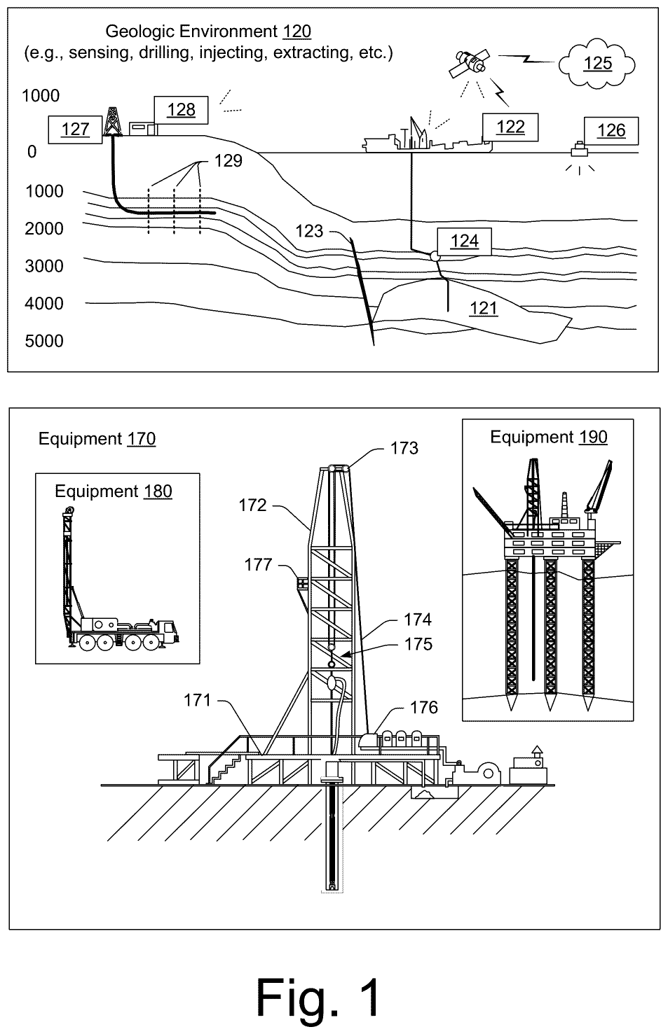

FIG. 1 shows an example of a geologic environment 120. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with a variety of sensors, detectors, actuators, etc. For example, equipment 122 may include communication circuitry to receive and to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more pieces of equipment may provide for measurement, collection, communication, storage, analysis, etc. of data (e.g., for one or more produced resources, etc.). As an example, one or more satellites may be provided for purposes of communications, data acquisition, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, assessment of one or more fractures, injection, production, etc. As an example, the equipment 127 and/or 128 may provide for measurement, collection, communication, storage, analysis, etc. of data such as, for example, production data (e.g., for one or more produced resources). As an example, one or more satellites may be provided for purposes of communications, data acquisition, etc.

FIG. 1 also shows an example of equipment 170, an example of equipment 180, and an example of equipment 190. Such equipment, which may be systems of components, may be suitable for use in the geologic environment 120. The equipment 170 and 180 are illustrated as land-based, various components may be suitable for use in an offshore system, for example, as shown for the equipment 190.

The equipment 170 includes a platform 171, a derrick 172, a crown block 173, a line 174, a traveling block assembly 175, drawworks 176 and a landing 177 (e.g., a monkeyboard). As an example, the line 174 may be controlled at least in part via the drawworks 176 such that the traveling block assembly 175 travels in a vertical direction with respect to the platform 171. For example, by drawing the line 174 in, the drawworks 176 may cause the line 174 to run through the crown block173 and lift the traveling block assembly 175 skyward away from the platform 171; whereas, by allowing the line 174 out, the drawworks 176 may cause the line 174 to run through the crown block 173 and lower the traveling block assembly 175 toward the platform 171. Where the traveling block assembly 175 carries pipe (e.g., casing, etc.), tracking of movement of the traveling block 175 may provide an indication as to how much pipe has been deployed.

A derrick may be a structure used to support a crown block and a traveling block operatively coupled to the crown block at least in part via line. A derrick may be pyramidal in shape and offer a suitable strength-to-weight ratio. A derrick may be movable as a unit or in a piece-by-piece manner (e.g., to be assembled and disassembled).

As an example, drawworks may include a spool, brakes, a power source and assorted auxiliary devices. Drawworks may controllably reel out and reel in line. Line may be reeled over a crown block and coupled to a traveling block to gain mechanical advantage in a “block and tackle” or “pulley” fashion. Reeling out and in of line may cause a traveling block (e.g., and whatever may be hanging underneath it), to be lowered into or raised out of a bore. Reeling out of line may be powered by gravity and reeling in by a motor, an engine, etc. (e.g., an electric motor, a diesel engine, etc.).

As an example, a crown block may include a set of pulleys (e.g., sheaves) that may be located at or near a top of a derrick or a mast, over which line is threaded. A traveling block may include a set of sheaves that may be moved up and down in a derrick or a mast via line threaded in the set of sheaves of the traveling block and in the set of sheaves of a crown block. A crown block, a traveling block and a line may form a pulley system of a derrick or a mast, which may enable handling of heavy loads (e.g., drillstring, pipe, casing, liners, etc.) to be lifted out of or lowered into a bore. As an example, line may be about a centimeter to about five centimeters in diameter as, for example, steel cable. Through use of a set of sheaves, such line may carry loads heavier than the line could support as a single strand.

As an example, a derrickman may be a rig crew member that works on a platform attached to a derrick or a mast. A derrick may include a landing on which a derrickman may stand. As an example, such a landing may be about 10 meters or more above a rig floor. In an operation referred to as trip out of the hole (TOH), a derrickman may wear a safety harness that enables leaning out from the work landing (e.g., monkeyboard) to reach pipe in located at or near the center of a derrick or a mast and to throw a line around the pipe and pull it back into its storage location (e.g., fingerboards), for example, until it a time at which it may be desirable to run the pipe back into the bore. As an example, a rig may include automated pipe-handling equipment such that the derrickman controls the machinery rather than physically handling the pipe.

As an example, a trip may refer to the act of pulling equipment from a bore and/or placing equipment in a bore. As an example, equipment may include a drillstring that may be pulled out of a hole and/or placed or replaced in a hole. As an example, a pipe trip may be performed where a drill bit has dulled or has otherwise ceased to drill efficiently and is to be replaced.

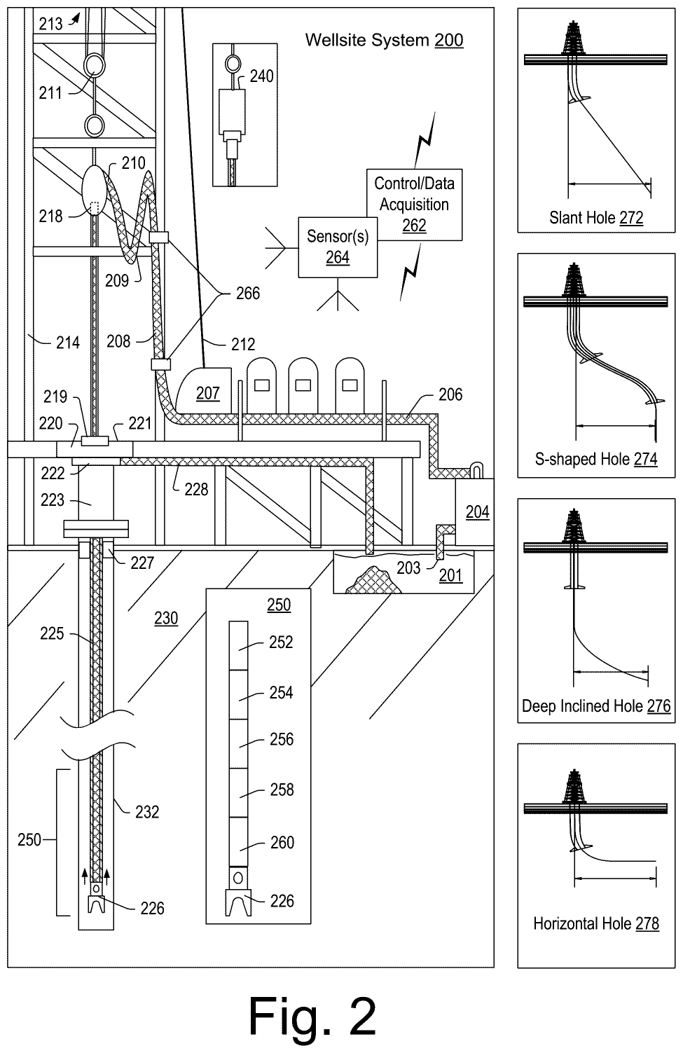

FIG. 2 shows an example of a wellsite system 200 (e.g., at a wellsite that may be onshore or offshore). As shown, the wellsite system 200 may include a mud tank 201 for holding mud and other material (e.g., where mud may be a drilling fluid), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212 (see, e.g., the crown block 173 of FIG. 1), a derrick 214 (see, e.g., the derrick 172 of FIG. 1), a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use directional drilling.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 may provide for operation of the drillstring 225 and other operations. As shown, the wellsite system 200 includes the platform 211 and the derrick 214 positioned over the borehole 232. As mentioned, the wellsite system 200 may include the rotary table 220 where the drillstring 225 pass through an opening in the rotary table 220.

As shown in the example of FIG. 2, the wellsite system 200 may include the kelly 218 and associated components, etc., or a top drive 240 and associated components. As to a kelly example, the kelly 218 may be a square or hexagonal metal/alloy bar with a hole drilled therein that serves as a mud flow path. The kelly 218 may be used to transmit rotary motion from the rotary table 220 via the kelly drive bushing 219 to the drillstring 225, while allowing the drillstring 225 to be lowered or raised during rotation. The kelly 218 may pass through the kelly drive bushing 219, which may be driven by the rotary table 220. As an example, the rotary table 220 may include a master bushing that operatively couples to the kelly drive bushing 219 such that rotation of the rotary table 220 may turn the kelly drive bushing 219 and hence the kelly 218. The kelly drive bushing 219 may include an inside profile matching an outside profile (e.g., square, hexagonal, etc.) of the kelly 218; however, with slightly larger dimensions so that the kelly 218 may freely move up and down inside the kelly drive bushing 219.

As to a top drive example, the top drive 240 may provide functions performed by a kelly and a rotary table. The top drive 240 may turn the drillstring 225. As an example, the top drive 240 may include one or more motors (e.g., electric and/or hydraulic) connected with appropriate gearing to a short section of pipe called a quill, that in turn may be screwed into a saver sub or the drillstring 225 itself. The top drive 240 may be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 may hold mud, which may be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via the lines 206, 208 and 209 to a port of the kelly 218 or, for example, to a port of the top drive 240. The mud may then flow via a passage (e.g., or passages) in the drillstring 225 and out of ports located on the drill bit 226 (see, e.g., a directional arrow). As the mud exits the drillstring 225 via ports in the drill bit 226, it may then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drillstring 225 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drillstring 225 at a bottom of a wellbore, pumping of the mud commences to lubricate the drill bit 226 for purposes of drilling to enlarge the wellbore. As mentioned, the mud may be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more modules of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud may cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254 (e.g., a LWD tool), a measuring-while-drilling (MWD) module 256 (e.g., a MWD tool), an optional module 258, a roto-steerable system (RSS) and/or motor 260, and the drill bit 226. Such components or modules may be referred to as tools where a drillstring may include a plurality of tools.

As to an RSS, it involves technology utilized for directional drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling may commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor may present some challenges depending on factors such as rate of penetration (ROP), transferring weight to a bit (e.g., weight on bit, WOB) due to friction, etc. A mud motor may be a positive displacement motor (PDM) that operates to drive a bit (e.g., during directional drilling, etc.). A PDM operates as drilling fluid is pumped through it where the PDM converts hydraulic power of the drilling fluid into mechanical power to cause the bit to rotate.

As an example, a PDM may operate in a combined rotating mode where surface equipment is utilized to rotate a bit of a drillstring (e.g., a rotary table, a top drive, etc.) by rotating the entire drillstring and where drilling fluid is utilized to rotate the bit of the drillstring. In such an example, a surface RPM (SRPM) may be determined by use of the surface equipment and a downhole RPM of the mud motor may be determined using various factors related to flow of drilling fluid, mud motor type, etc. As an example, in the combined rotating mode, bit RPM may be determined or estimated as a sum of the SRPM and the mud motor RPM, assuming the SRPM and the mud motor RPM are in the same direction.

As an example, a PDM mud motor may operate in a so-called sliding mode, when the drillstring is not rotated from the surface to drive a drill bit in a particular cutting direction. In such an example, a bit RPM may be determined or estimated based on the RPM of the mud motor. As an example, during a sliding mode, oscillation of a drillstring may be provided by surface equipment, for example, to oscillate the drillstring in a clockwise and a counter-clockwise direction, which may, for example, help to reduce risk of sticking, etc.

An RSS may drill directionally where there is continuous rotation from surface equipment, which may alleviate the sliding of a steerable motor (e.g., a PDM). An RSS may be deployed when drilling directionally (e.g., deviated, horizontal, or extended-reach wells). An RSS may aim to minimize interaction with a borehole wall, which may help to preserve borehole quality. An RSS may aim to exert a relatively consistent side force akin to stabilizers that rotate with the drillstring or orient the bit in the desired direction while continuously rotating at the same number of rotations per minute as the drillstring.

The LWD module 254 may be housed in a suitable type of drill collar and may contain one or a plurality of selected types of logging tools. It will also be understood that more than one LWD and/or MWD module may be employed. Where the position of a module is mentioned, as an example, it may refer to a module at the position of the LWD module 254, the MWD module 256, etc. An LWD module may include capabilities for measuring, processing, and storing information, as well as for communicating with the surface equipment. In the illustrated example, the LWD module 254 may include a seismic measuring device.

The MWD module 256 may be housed in a suitable type of drill collar and may contain one or more devices for measuring characteristics of the drillstring 225 and the drill bit 226. As an example, the MWD module 256 may include equipment for generating electrical power, for example, to power various components of the drillstring 225. As an example, the MWD module 256 may include the telemetry equipment 252, for example, where the turbine impeller may generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

FIG. 2 also shows some examples of types of holes that may be drilled. For example, consider a slant hole 272, an S-shaped hole 274, a deep inclined hole 276 and a horizontal hole 278.

As an example, a drilling operation may include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees.

As an example, a directional well may include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of one or more of an RSS, a downhole motor and/or a turbine. As to a motor, for example, a drillstring may include a positive displacement motor (PDM).

As an example, geosteering may include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 may include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 may be provided for tracking pipe, tracking movement of at least a portion of a drillstring, etc.

As an example, the system 200 may include one or more sensors 266 that may sense and/or transmit signals to a fluid conduit such as a drilling fluid conduit (e.g., a drilling mud conduit). For example, in the system 200, the one or more sensors 266 may be operatively coupled to portions of the standpipe 208 through which mud flows. As an example, a downhole tool may generate pulses that may travel through the mud and be sensed by one or more of the one or more sensors 266. In such an example, the downhole tool may include associated circuitry such as, for example, encoding circuitry that may encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 may include a transmitter that may generate signals that may be transmitted downhole via mud (e.g., drilling fluid) as a transmission medium.

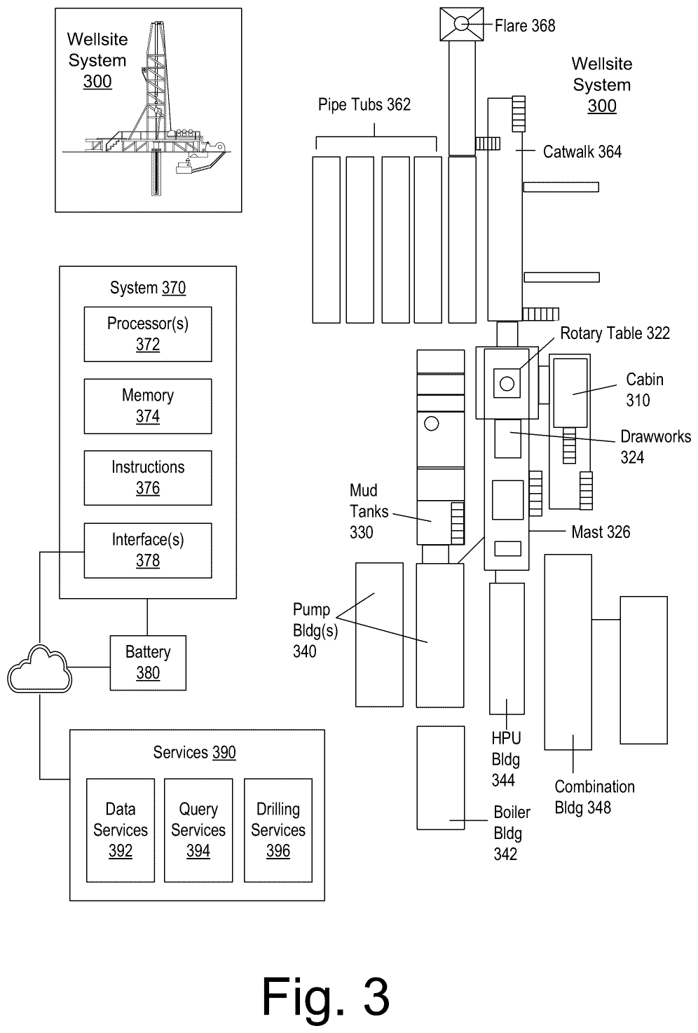

FIG. 3 shows an example of a wellsite system 300, specifically, FIG. 3 shows the wellsite system 300 in an approximate side view and an approximate plan view along with a block diagram of a system 370.

In the example of FIG. 3, the wellsite system 300 may include a cabin 310, a rotary table 322, drawworks 324, a mast 326 (e.g., optionally carrying a top drive, etc.), mud tanks 330 (e.g., with one or more pumps, one or more shakers, etc.), one or more pump buildings 340, a boiler building 342, an HPU building 344 (e.g., with a rig fuel tank, etc.), a combination building 348 (e.g., with one or more generators, etc.), pipe tubs 362, a catwalk 364, a flare 368, etc. Such equipment may include one or more associated functions and/or one or more associated operational risks, which may be risks as to time, resources, and/or humans.

As shown in the example of FIG. 3, the wellsite system 300 may include a system 370 that includes one or more processors 372, memory 374 operatively coupled to at least one of the one or more processors 372, instructions 376 that may be, for example, stored in the memory 374, and one or more interfaces 378. As an example, the system 370 may include one or more processor-readable media that include processor-executable instructions executable by at least one of the one or more processors 372 to cause the system 370 to control one or more aspects of the wellsite system 300. In such an example, the memory 374 may be or include the one or more processor-readable media where the processor-executable instructions may be or include instructions. As an example, a processor-readable medium may be a computer-readable storage medium that is not a signal and that is not a carrier wave.

FIG. 3 also shows a battery 380 that may be operatively coupled to the system 370, for example, to power the system 370. As an example, the battery 380 may be a back-up battery that operates when another power supply is unavailable for powering the system 370. As an example, the battery 380 may be operatively coupled to a network, which may be a cloud network. As an example, the battery 380 may include smart battery circuitry and may be operatively coupled to one or more pieces of equipment via a SMBus or other type of bus.

In the example of FIG. 3, services 390 are shown as being available, for example, via a cloud platform. Such services may include data services 392, query services 394 and drilling services 396. As an example, the services 390 may be part of a system (e.g., consider planning services and/or operational services). As an example, the services 390 may include one or more services for directional drilling (e.g., consider a computational framework that may provide for one or more services that utilize real-time data to estimate one or more parameters, etc.).

As an example, the system 370 may be utilized to generate one or more rate of penetration drilling parameter values, which may, for example, be utilized to control one or more drilling operations.

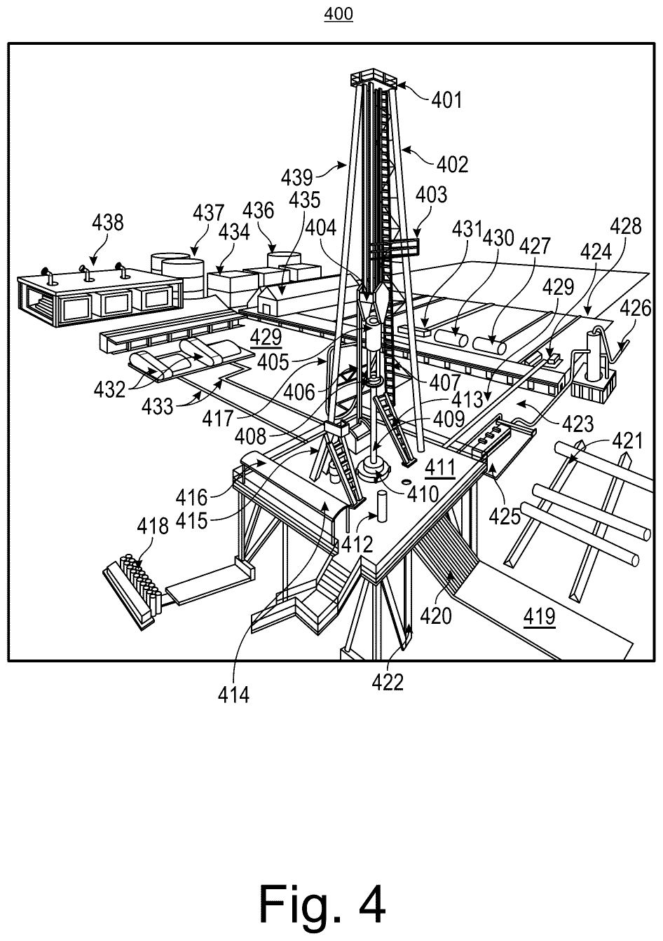

FIG. 4 shows an example of a system 400 that includes a crown block 401, a mast 402, a monkey board 403, a traveling block 404, a hook 405, a swivel 406, elevators 407, a kelly 408, a kelly bushing 409, a master bushing 410, a mousehole 411, a rathole 412, a drawworks 413, a weight indicator 414, a driller's console 415, a doghouse 416, a rotary hose 417, an accumulator unit 418, a catwalk 419, a pipe ramp 420, a pipe rack 421, a substructure 422, a mud return line 423, a shale shaker 424, a choke manifold 425, a mud gas separator 426, a degasser 427, a reserve pit 428, mud pits 429, a desander 430, a desilter 431, mud pumps 432, mud discharge lines 433, a bulk mud components storage 434, a mud house 435, a water tank 436, a fuel storage 437, engines and generators 438 and drilling line 439.

As shown in FIG. 4, the system 400 may include a variety of components that are set within a three-dimensional environment as may be associated with a well and referred to as a wellsite or a rig site, noting that either may include a rig or rigs. As an example, one or more cameras may be included in the system 400, which may be fixed position cameras and/or mobile cameras. For example, a mobile camera may be a drone type of camera that may navigate a site.

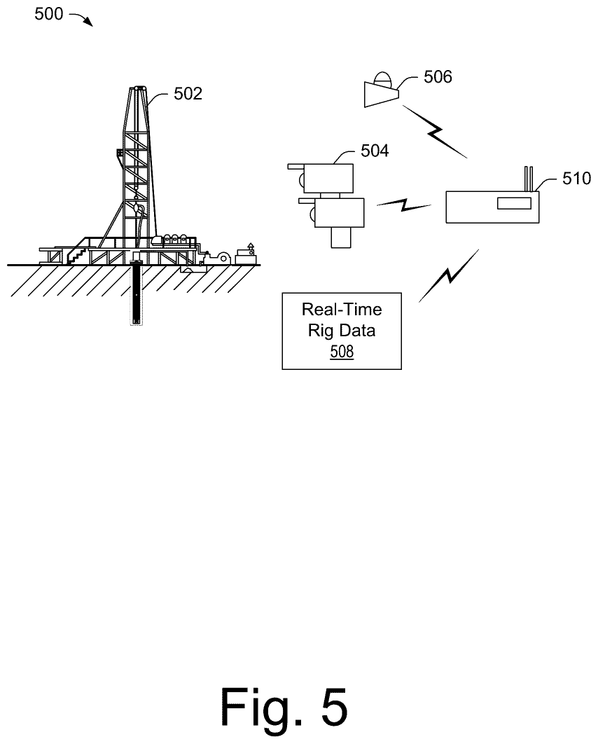

FIG. 5 illustrates a simplified schematic view of an oilfield rig system 500, according to an embodiment. The rig system 500 may generally include a rig 502, which may include a derrick, a rig floor, tubular handling equipment, drilling equipment, drilling controls, pipe racks, a catwalk, etc. The rig system 500 may also include one or more cameras 504, which may be strategically positioned on the rig 502 to acquire optical data (images) of different areas (or zones) on the rig 502. In particular, at different times during the operation of the rig 502, certain areas may be restricted, that is, not safe for human access. One or more of the cameras 504 may be positioned to permit visual monitoring of such potentially restricted areas.

The rig system 500 may also include alarm 506, which may be a visual, audible, or another type of alarm. The rig system 500 may further include rig sensors 508, which may generate real-time rig data, from which a rig state may be inferred. The rig state may correspond to certain equipment being active, which may, in turn, result in certain areas of the rig 502 being restricted based on rules, as will be described in greater detail below. The real-time rig data may include rig sensor measurements, such as a hook load, drilling rotation speed, power consumption by and/or location of different pieces of equipment, etc.

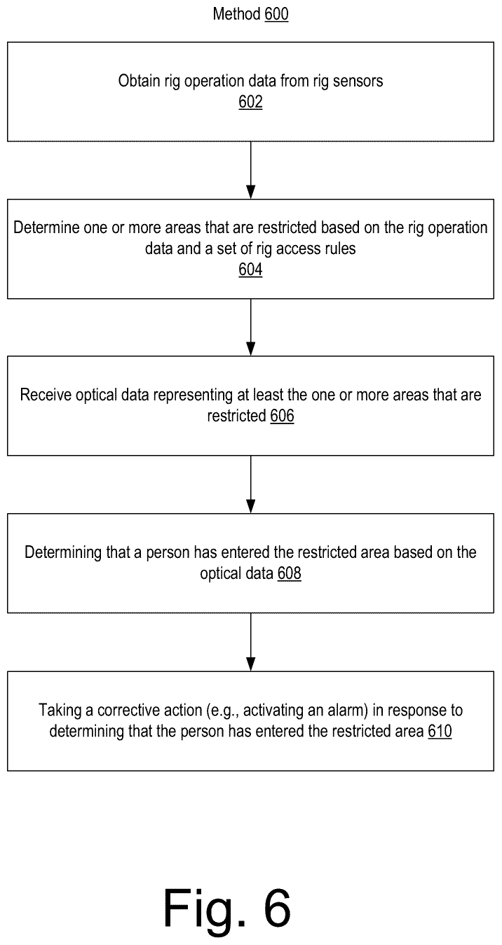

The rig system 500 may further include a processor 510 that may collect the real-time data from the rig sensors 508 (at relatively low frequency, e.g., 10 Hz) and the cameras 504 (at relatively high frequency, e.g., 30 fps). The processor 510 may include a computer-readable medium storing instructions that, when executed by the processor 510, cause the processor 510 (or another part of the rig system 500) to perform operations. Such operations may include the method 600 shown in the flowchart of FIG. 6. In this embodiment, the method 600 may include obtaining real-time rig data (or “rig operation data”) from the rig sensors 508, as at 602 and schematically depicted in FIG. 5. From this real-time rig operation data, the processor 510 may determine one or more areas of the rig that are restricted based on the rig operation data and a set of rig access rules, as at 604. For example, the processor 510 may infer a rig state (e.g., certain equipment that is being operated) based on the rig operation data. The access rules may associate different rig states with rig areas that are restricted from access, e.g., around the active equipment. Human presence in such restricted areas may be undesired as it presents a risk to the health and safety of the human. Accordingly, the processor 510 applying the rules may result in the demarcation of certain areas of the rig as restricted, based on the rig state.

The method 600 may also include the processor 510 receiving optical data representing at least the one or more areas that are restricted, as at 606. The cameras 504 may provide such optical data. Further, at least some of the cameras 504 may be pointed at non-restricted areas, while others are pointed at restricted areas, and, as noted above, whether and which areas are restricted may depend at least partially on the rig state and the rules applied thereto by the processor 510.

The processor 510 may include artificial intelligence processing capabilities that may detect the presence of a human in the restricted area based on the optical data from the camera(s) 504. Accordingly, the processor 510 may review the optical data received from the camera(s) 504 that view the restricted areas, and the processor 510 may determine that a person has entered the restricted area based on the optical data, as at 608.

The position of the cameras 504 relative to the restricted areas (e.g., the portion of the field of view of the camera that includes such areas) may also be pre-programmed or otherwise determined by the processor 510 based on the camera 504 position and orientation, rig features, signs, etc. Thus, the location of the human in the field of view of a camera 504 may be determined and compared to the location of the restricted area in the same field of view. In other embodiments, the mere presence of the human in the field of view may indicate the human is present in a restricted area. Furthermore, the cameras 504 may be positioned to complement one another, e.g., in situations where moving equipment may sometimes obstruct the view of one or more cameras. In such cases, the processor 510 may be programmed to adjust the view of one or more cameras 504 to account for the obstruction to another camera 504 and maintain view of the restricted area(s). As such, a coordination of the cameras 504 and interpretation of the optical data from potentially several cameras simultaneously may be employed to monitor the rig.

At this point, the processor 510 may have determined both that one of the camera 504 views includes a restricted area, and that a human has entered the restricted area within the camera 504 view. Accordingly, the health and safety of the human may be at risk, and thus the processor 510 may take a corrective action, such as activating the alarm 506) in response to determining that the person has entered the restricted area, as at 610.

As an example, a method for operating a drilling rig may include receiving real-time rig data representing an operational state of the rig; determining that an area of the rig is restricted based on the real-time rig data and a set of rules that associate rig states with restricted areas of the rig; receiving optical data representing at least a portion of the area of the rig that is restricted; determining that a human is present in the area of the rig that is restricted based on the optical data, where the optical data is processed using artificial intelligence to determine a presence of the human in the camera; and taking a corrective action in response to determining that the human is present in the area of the rig that is restricted.

As an example, a computing system may include one or more processors; and a memory system including one or more non-transitory computer-readable media storing instructions that, when executed by at least one of the one or more processors, cause the computing system to perform operations, the operations including: receiving real-time rig data representing an operational state of a drilling rig; determining that an area of the rig is restricted based on the real-time rig data and a set of rules that associate rig states with restricted areas of the rig; receiving optical data representing at least a portion of the area of the rig that is restricted; determining that a human is present in the area of the rig that is restricted based on the optical data, where the optical data is processed using artificial intelligence to determine a presence of the human in the camera; and taking a corrective action in response to determining that the human is present in the area of the rig that is restricted.

As an example, one or more non-transitory computer-readable media may store instructions that, when executed by one or more processors of a computing system, cause the computing system to perform operations, where the operations may include one or more of: receiving real-time rig data representing an operational state of a drilling rig; determining that an area of the rig is restricted based on the real-time rig data and a set of rules that associate rig states with restricted areas of the rig; receiving optical data representing at least a portion of the area of the rig that is restricted; determining that a human is present in the area of the rig that is restricted based on the optical data, where the optical data is processed using artificial intelligence to determine a presence of the human in the camera; and taking a corrective action in response to determining that the human is present in the area of the rig that is restricted.

As explained, rig data may indicate a rig state, which may be static or dynamic. A rig state may correspond to one of various types of states, as may be associated with particular actions. For example, consider actions such as making a BHA, connecting a BHA to drillpipe, lowering the BHA through a rig floor, contacting a drill bit of a BHA to a bottom of a hole, rotating the BHA (e.g., via a rotary table, a top drive, a downhole motor, etc.), pumping mud via drillpipe to lubricate the drill bit and remove cuttings from a borehole, removing cuttings from mud and recirculating the mud, adding drillpipe to the drillstring, tripping out to replace the drill bit and/or the BHA, etc.

For example, on the rig floor, a drilling crew makes up a BHA, which includes a drill bit, drill collars, stabilizers and in some cases, a reamer. The BHA may be augmented with LWD and/or MWD sensors, a downhole motor and a system for steering a BHA along a specified trajectory. A BHA may be changed from one section of a well to another to build, hold or drop an angle of wellbore inclination. A BHA may be connected to 31-ft (9.5-m) joints of heavyweight drillpipe that form a transition between drill collars of the BHA and standard drillpipe used to make up the drillstring.

As an example, a BHA may be hoisted using one or more types of equipment. For example, consider hoisting a BHA using a crane that may be able to move the BHA from and/or to an appropriate location. As explained, a BHA may include various components that are assembled together to define a BHA length. As an example, a BHA may be laid down, for example, horizontally or non-vertically. In such an example, a region may be provided for laying down the BHA. For example, consider a region that a crane may be able to navigate a BHA to for purposes of laying down and/or picking up. As an example, a BHA operation may differ in one or more aspects from a drillpipe operation. In such an example, a BHA may be moved differently than drillpipe. Hence, regions for drillpipe movement and for BHA movement may differ.

A BHA may be lowered through a rig floor, through a wellhead and into a conductor pipe. Once a drill bit of the BHA is on bottom, a hexagonal or square shaped pipe, known as a kelly, may be screwed into an uppermost joint of drillpipe. Depending on the type of surface rotation mechanism utilized, a kelly may be inserted into a kelly bushing (KB) to engage a rotary table. In such an example, as the rotary table turns the KB, which turns the kelly, the drillstring rotates (turning to the right in a clockwise rotation) and drilling begins. As mentioned, a top drive may be utilized, as may be coupled to an upper end of a drillstring. The commencement of drilling may be referred to as spudding in (e.g., recorded as the well's spud date).

As the drill bit bores deeper into a formation, additional lengths of drillpipe may be connected to a previous joint such that a drillstring grows progressively longer.

As explained, drilling fluid, or mud, may be pumped downhole to cool and lubricate a drill bit where mud also carries away rock cuttings created by the bit. Drilling fluids may be a specialized formulation of water or a nonaqueous continuous phase blended with powdered barite and other additives to control the rheology.

In various instances, a worn bit may be exchanged for a fresh bit (e.g., new, refurbished, etc.). As an example, a bit may wear out prior to completion of a section of may be changed upon drilling a new section (e.g., with a larger diameter, etc.). To change a bit, a drilling crew pulls a drillstring out of hole (e.g., pull out of hole (POOH)), which may be referred to as tripping out of the hole, to access a BHA and its bit. As an example, a POOH process may include circulating mud to bring cuttings and gas up to surface (e.g., circulating bottoms up) followed by roughnecks disconnecting a kelly from the drillstring and latching the uppermost joint of the drillstring to a derrick's elevators (e.g., metal clamps used for lifting pipe). As an example, a driller may control the drawworks that hoist the elevators up into the derrick. In such an example, one individual may control the drawworks while one or more other individuals may be near the hole for maneuvering equipment (e.g., pipe, elevators, slips, etc.). In various instances, a drillstring is pulled out of the hole one stand at a time where, for example, a stand consists of three joints of drillpipe connected together; noting that some rigs may be suited for singe drillpipe, two-joint stands, three-joint stands, or four or more joint stands, which may depend in part on derrick height. In a POOH operation, each stand may be unscrewed from the drillstring and then lined up vertically in rows, guided by a derrickman. As explained, a BHA is connected to drillpipe, where the BHA may be brought to surface with a section or section of drillpipe or as a separate assembly after drillpipe has been removed. As explained, a bit may be decoupled from a BHA, for example, to be graded on the basis of wear. As an example, an operation may involve removing a drill bit for purposes of assessment and/or replacing a drill bit. In a run-in-hole (RIH) operation, a BHA may be lowered into the hole followed by addition of drillpipe, which may be organized substantially vertically on a rig. A tripping out and tripping in process may be referred to as a round trip.

As explained, various operations may take place at a rig site where movement of equipment may depend on type of operation. As explained, making up a BHA may involve certain movements in one or more regions while a POOH operation may involve certain movements in one or more other regions. Where a rig site may have a set number of monitoring resources such as, for example, cameras, such cameras may be dynamically focused on one or more regions according to priority, which may be or include human safety priority. As an example, where a region is prioritized, multiple cameras may be focused on that region, which may be at the expense of another region. For example, consider zooming in on a region using multiple cameras to focus on that region for purposes of higher resolution and/or multiple perspectives (e.g., for easier motion assessment, 3D localization, etc.) while zooming out on another camera such that it may capture a larger field of view (FOV) but at a lesser resolution, which may be sufficient for more general monitoring of one or more other regions where risks may be deemed low or priority low.

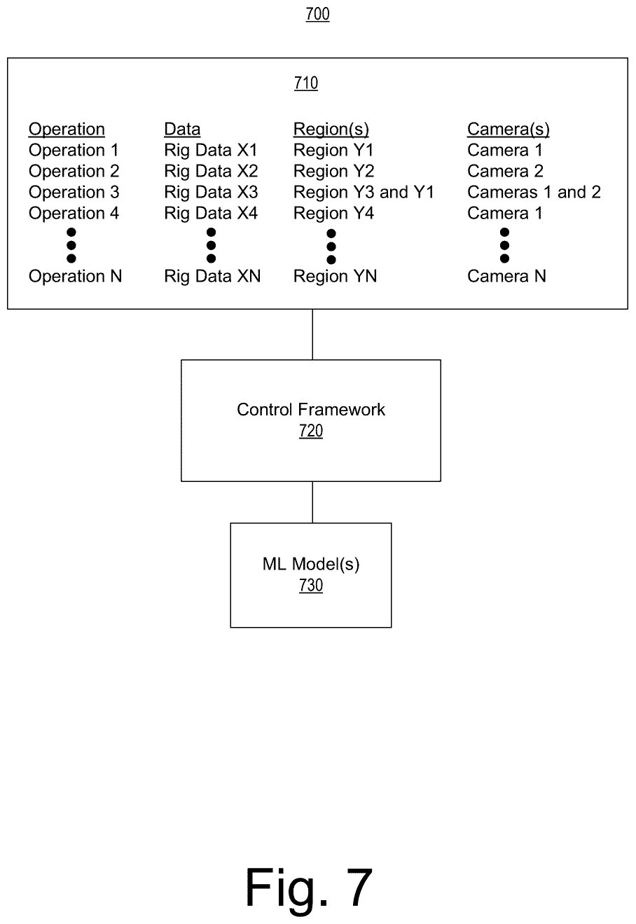

FIG. 7 shows an example of a system 700 that includes a data structure 710, a control framework 720 and one or more machine learning models 730 (ML model(s)). As shown, the data structure 710 may provide for associating operations with data, regions and cameras. In such an example, the control framework 720 may provide for dynamically generating the data structure 710, which may do so using one or more of the one or more ML models 730. For example, consider an approach where rig data may be utilized in combination with imagery (e.g., image data) to associate operations and regions where such regions may be monitored for purposes such as, for example, human safety. In such an example, a region may be identified dynamically as being a region with a level of risk as to human safety whereby one or more cameras may be aimed to capture imagery of the region to assess whether one or more humans may be present near or in the region and/or moving toward and/or away from the region such that appropriate action may be taken to help assure human safety. In such an approach, resources at a rig site may be focused to help address risk in a tiered manner. For example, consider focusing camera and/or computational resources on assessing a high-risk region. In such an example, a high-risk region may be determined dynamically and be prioritized over one or more other regions for purposes of resource utilization (e.g., cameras, ML model-based assessments, etc.). In such an example, either fewer resources may be deployed at a rig site and/or resources may be utilized more effectively in a dynamic manner.

As an example, the control framework 720 may provide for issuance of signals, transmission of data, etc., for one or more purposes. For example, consider risk mitigation where an alarm may be issued to a device in a region and/or carried by an individual. In such an example, the control framework 720 may transmit appropriate imagery which may include one or more annotations that may be rendered to a display of a device (e.g., a wearable, a mobile phone, a tablet, etc.). In such an example, the imagery may be video imagery at a lesser resolution or framerate such that bandwidth restrictions may not result in a substantial delay (e.g., latency). For example, consider a pipe moving in a region where a risk of the pipe hitting a human may exist. In such an example, the control framework 720 may issue an alarm such that the human may look at a display to see the moving pipe and an annotation of the pipe's direction which may be toward that human. As explained, where multiple cameras are utilized, a 3D visualization may be generated such that a human may become more keenly aware of a risk. As an example, the control framework 720 may provide for transmission of an instruction as to movement of the human to reduce risk, which may be via an annotation renderable to a display and/or an audio instruction (e.g., “move four steps to your left”).

As an example, a control framework may provide for data reduction, compression, etc. For example, consider cropping of imagery to reduce data size, resampling of imagery to reduce data size, framerate reduction to reduce data size of video (e.g., one or more clips), time-based editing to reduce data size, etc. As to cropping, consider identifying an individual and a relevant portion of an environment (e.g., a region) within an extent of an image and cropping to generate a cropped image of a lesser size than the image. In such an example, the cropped image may be transmitted to the cloud, a mobile device, a storage device, etc., in a manner that utilizes less bandwidth and/or transmission resources than a full, non-cropped image. As to resampling, consider resampling a portion or portions of an image to generate a down-sampled image of lesser size than the image. As an example, a filtering-based approach may be utilized for resampling. As an example, a compression technique may be applied to an image or a reduced image to further reduce data size. As to framerate reduction, consider deleting certain frames from a video, which may be every other frame or another approach. As to time-based editing, consider an approach that may utilize motion detection to isolate one or more portions of a video stream such that one or more relevant portions may be isolated, with a reduced data size compared to full video.

As an example, one or more techniques may be applied to facilitate labeling, which may provide for generation of labeled imagery that may be suitable for training, re-training, etc., one or more ML models. As an example, one or more techniques may include one or more data reduction techniques such as, for example, cropping, etc. As an example, a control framework may provide for automated and/or semi-automated labeling. For example, consider an approach where imagery may be transmitted to a device where a user may view the imagery, which may be also annotated, such that one or more labels may be applied, confirmed, etc. In such an example, consider a forensic analysis to be performed by an individual at the end of a work shift where the individual has to review each noted incident (e.g., warning, actual impact by an object, violation of space as to a restricted region, etc.), where such review may generate feedback suitable for use in training, re-training, testing, re-testing, etc., one or more ML models. In such an approach, a control framework may gain in intelligence as more issues are identified, addressed, etc. In such an approach, recommendations as to mitigating actions may be improved such that one or more individuals may be more appropriately warned, instructed, etc., for example, to reduce risk and/or otherwise avoid being impacted by an object or objects.

As mentioned, one or more cameras may be utilized for acquiring image data. While cameras may be considered, a rig site may include one or more other types of devices, additionally or alternatively. For example, consider laser, LIDAR, sonar, etc. As to LIDAR, it is an acronym of “light detection and ranging” or “laser imaging, detection, and ranging”, which is a technology for determining ranges by targeting an object or a surface with a laser and measuring the time for the reflected light to return to the receiver. LIDAR may operate in a fixed direction (e.g., vertical) or it may scan multiple directions, in which case it may be referred to as LIDAR scanning or 3D laser scanning, a special combination of 3-D scanning and laser scanning. As an example, one or more range finding technologies and/or techniques may be employed.

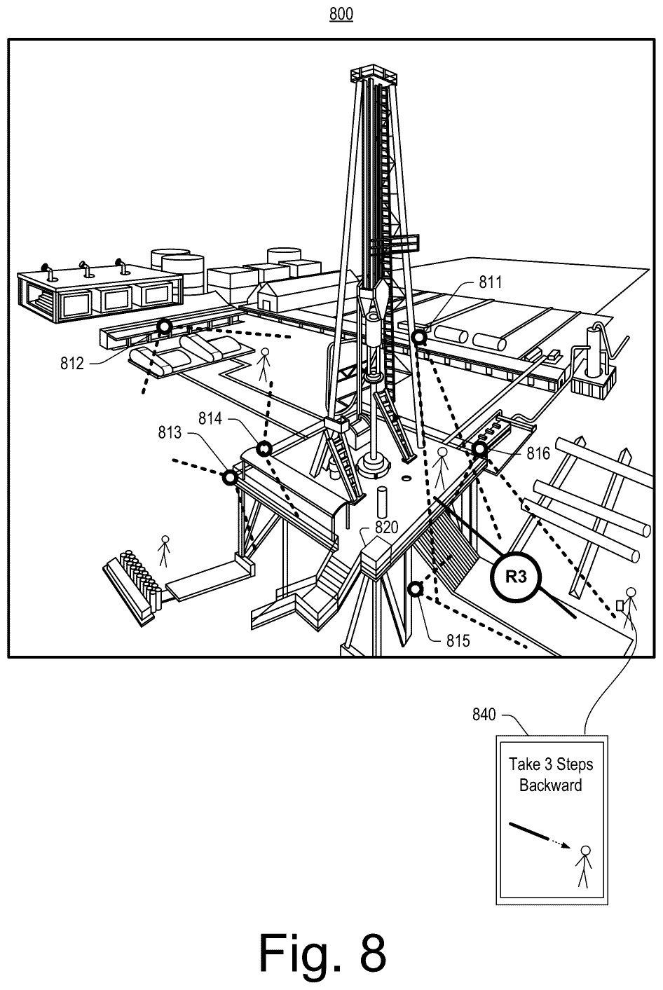

FIG. 8 shows an example of a system 800 that includes a number of imagery sensors 811, 812, 813, 814, 815, and 816 and a control framework 820. In the example of FIG. 8, a region, labeled R3, has been identified as being a priority region, for example, as to a level of risk. In the example of FIG. 8, responsive to the identification of a high priority region, R3, various imagery sensors are focused to capture imagery from multiple perspectives of the region R3. Further, various other imagery sensors may be zoomed out and/or otherwise controllably positioned to capture regions of concern but of lesser priority and/or risk. In such an approach, resources are dedicated based on priority and/or risk responsive to identification of one or more regions, as may be based on rig data, imagery data, etc., which, as explained, may be processed using one or more ML models as may be part of or operatively coupled to the control framework 820.

As shown in the example of FIG. 8, a human may have a device 840 that may be a mobile device that may receive signals from the control framework 820 such that the human may be alerted and instructed, for example, via a live feed and/or reconstruction, which may be annotated with a likely direction of movement of equipment with respect to position of the human. For example, consider a pipe likely to move toward the human, as may be predicted via one or more ML models, such that the human may become aware of such a situation to mitigate risk. In such an example, a graphical user interface (GUI) may be rendered that may provide for feedback and/or one or more types of motion and/or location circuitry may be present within the device 840 to indicate that the human has taken some action, which may be compared with the instructed action to determine whether the risk has been mitigated by following recommended action and/or taking other action. Such feedback may be utilized by one or more frameworks to, for example, train one or more ML models that may be utilized to determine recommended action, risk level, etc., for one or more future scenarios.

In the example of FIG. 8, the imagery sensors 811, 815, and 816 are shown to be focused on region R3. As shown, imagery data may be acquired from multiple perspectives such that, for example, a 3D model may be constructed and/or such that, for example, one or more obstructions may be present yet imagery available due to multiple perspectives. As an example, a model-based approach may provide for constructing what may not be seen due to obstruction. For example, consider a pipe, which is known to be substantially straight such that a model may construct a full pipe given a portion or portions of the pipe within imagery data. In such an approach, a control framework may provide for overcoming one or more types of obstruction issues.

In the example of FIG. 8, once the issues with region R3 have been adequately addressed and/or dissipated, the control framework 820 may control one or more of the imagery sensors 811, 812, 813, 814, 815, and 816 to return to a base state and/or to focus on one or more other regions, as may be determined using rig data, etc.

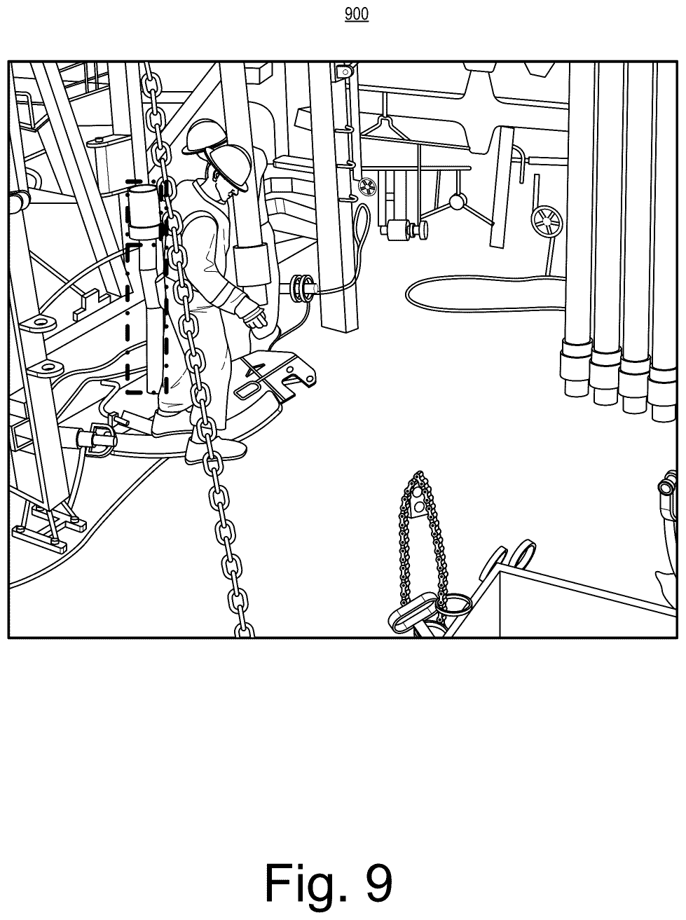

FIG. 9 shows an example of annotated imagery 900 that indicates a relatively small region of concern, as outlined by one or more boxes. In such an example, annotations may be dynamic and aim to highlight one or more regions of concern, with respect to risk, etc. As explained, a mobile device may be utilized for alarming an individual or individuals and, for example, rendering one or more visualizations, which, may include one or more animations (e.g., model-based animations, etc.). As explained, a control framework may provide for generation of a model, missing imagery, predictions, annotations, animations, etc.

As shown in the system 300 of FIG. 3 and the system 400 of FIG. 4, a system may include a catwalk (see, e.g., the catwalk 364 and the catwalk 419). A catwalk may be a relatively long, rectangular platform about 0.9 m high, usually made of steel and located perpendicular to a vee-door at a bottom of a slide. The catwalk may be used as a staging area for rig and drillstring tools, for example, components that are about to be picked up and run, or components that have been run and are being laid down. A catwalk may be a functional staging area on an offshore rig, though it may not necessarily be a separate or raised structure.

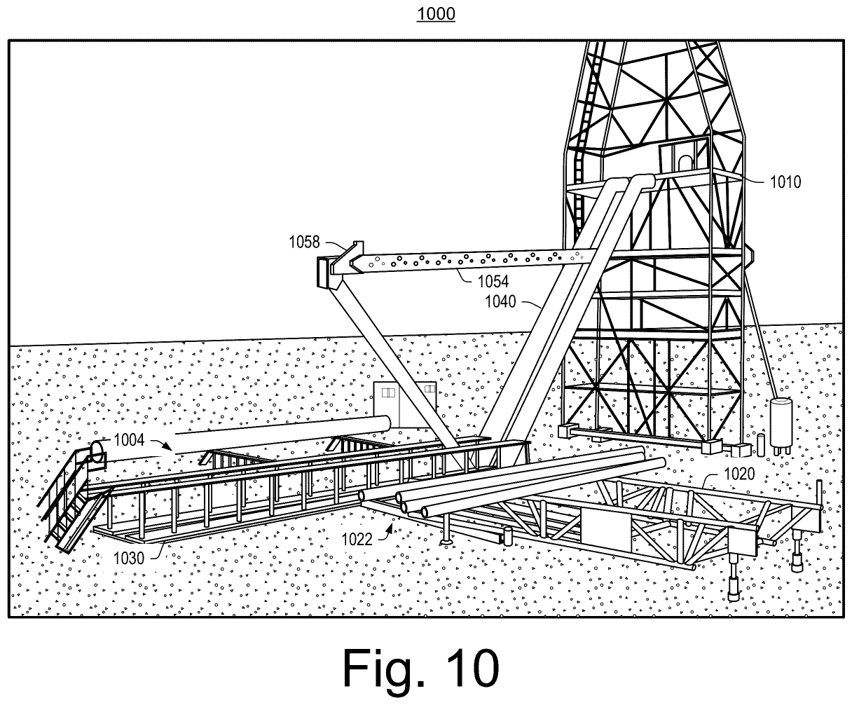

FIG. 10 shows an example of a system 1000 that includes various catwalk features of a catwalk 1004, including a rig floor 1010, a pipe rack 1020, pipes 1022, a catwalk deck 1030, a ramp 1040, a support arm 1050, a transfer arm 1054, and a push device 1058, which may be arranged with respect to the rig floor 1010 and the pipe rack 1020 to transfer pipes from the pipe rack 1020 to the rig floor 1010 and/or to transfer pipes from the rig floor 1010 to the pipe rack 1020.

As an example, a catwalk may be a relatively long platform that may be elevated (e.g., consider one meter above a pad, etc.), which may be made of steel or other suitable material and located substantially perpendicular to a vee-door at the bottom of a ramp (e.g., a slide). A catwalk may be used as a staging area for rig and drillstring components, such as, for example, components that are about to be picked up and run, or components that have been run and are being laid down. A catwalk may provide staging area functionality, whether on-shore or off-shore, noting that for off-shore drilling rigs, a catwalk may not necessarily be a separate or raised structure.

A catwalk may serve as a staging area for a rig and drilling component activities and may provide for implementation of one or more safety strategies. A well-designed catwalk may help to reduce tubular handling and may help to minimize operating hazards, for example, to help create a safer, more efficient rig site.

In operation, a drillstring component may be rolled from a pipe rack to a transfer arm where the transfer arm may be lifted hydraulically via a support arm. Once properly positioned, a pusher device may provide for pushing the drillstring component along the transfer arm such that a portion of the drillstring device extends over a rig floor. Operation of a catwalk system may be via an operator station, for example, with levers, buttons, etc., that may provide for manual control of the catwalk system.

As an example, a catwalk system may include hydraulic gull wings, a tubular skate with adjustable hood, hydraulic leveling jacks, a tubular laydown shovel, podium style control station, an integrated HPU, a trough skate to push and receive tubulars along the length of the trough, interlocked trough kickers to help prevent inadvertent operation when the trough is away from its home position, hydraulically synchronized indexers and kickers, a hydraulically deployed stabilizing system, wireless remote control, adjustable rig floor height, an indexer interface to help prevent dropped tubulars, a skate interface to help prevent kickers from operating beneath the skate, etc.

As an example, a catwalk system may provide for hands-off transportation of tubulars between ground level and a drill floor; automated operation from a driller cabin and/or remote control; handling of casing tong, stabilizers, subs, and other tools between ground level and a drill floor; thread protection for casing; increased personnel safety from use of an integrated manipulator arm; ramp with pusher unit operation for tubular transport; an anticollision system; a feeding system for drillpipe, drill collar, and casing; etc. As an example, a catwalk system may include one or more features of the Cameron SMARTCAT system (SLB, Houston, Texas).

As an example, a framework may provide for addressing security risks related to catwalk operation in drilling rigs. For example, a framework may provide for detecting when it is unsafe for people to be close to the catwalk.

As an example, a framework may address one or more HSE problems by understanding through computer algorithms and/or one or more ML models when a catwalk is in operation and, for example, when one or more people are standing in places where they may be at risk (e.g., inappropriate places where risk of being hit by an object may be substantial). For example, during various types of catwalk operations, it may be advisable to reduce risk by not having any individual within a distance or distances of one or more features of a catwalk (e.g., not in proximity to the catwalk).

As an example, a framework may use a mix of techniques to generalize movement happening in a catwalk and whether, for example, movement pertains to an empty pusher or a pusher with a pipe attached to it (e.g., operatively coupled to it), which may substantially increase risk to someone close to the catwalk (e.g., within a pipe length, etc.). As an example, a framework may mix such a technique with one or more machine learning techniques to detect one or more people nearby a catwalk, for example, to issue an alert as may be based on a level of risk, an immediacy of risk, etc.

As an example, a framework may provide for accident reduction by detecting a catwalk in motion and alerting one or more people if someone is at risk of getting struck by one or more objects in movement.

As an example, a framework may generate an alert once a non-compliance event occurs where, for example, the alert may be stored in a database where users may be given a choice to connect a siren and/or one or more other alert mechanisms to alert one or more workers in real-time. With an alerts database, a framework may generate value by showing HSE non-compliance trends (e.g., monthly, weekly, daily, etc.). As an example, with a siren, value may be derived by alerting individuals in real-time about dangers to actual workers in the rig, potentially saving one or more of them from harm.

As an example, a system may include one or more cameras that may capture imagery in a three-dimensional environment. As an example, a framework may include one or more interfaces for receipt of imagery, for example, via wired and/or wireless connections. As an example, a framework may provide for detecting regions in video feeds that may pose a danger to field engineers while handling equipment.

As an example, a framework may utilize one or more trained machine learning models (ML models), which may be fine-tuned on images from the field to detect the presence and location of equipment of interest. As an example, on detection of multiple equipment, a framework may implement a technique to determine a zone within a work area where there may be a serious risk of injury from the machinery, for example, based on movement and/or position where movement may be characterized as position with respect to time. While machinery is mentioned, imagery may provide for detection of non-machinery, such as, for example, heat, fluid (e.g., liquid and/or gas), solids, chemicals (e.g., CO2, combustion products, etc.), etc.

As an example, a framework may implement techniques that may combine the use of object detection models with subject-matter specific experimental algorithms, for example, as part of a suite of vision analytics solutions. As an example, a framework may be deployed as a lightweight edge-based lloT solution in field.

As an example, a framework may utilize one or more types of models to detect equipment and/or other materials (e.g., solid, gas, liquid, etc.) even in low light environments and under various types of weather conditions, whereby the framework may predict motion of the equipment and/or other materials, for example, based on velocity computations and positions. As an example, a framework may provide for generating and issuing alerts automatically for personnel if they are breaching a “line of fire” (e.g., a zone in which motion detection and analysis may consider hazardous, etc.).

As an example, a framework may improve proactive safety of field personnel at a site, whether on a rig floor handling torquing equipment or elsewhere. As an example, a framework may utilize one or more of AI techniques, machine learning techniques, computer vision techniques, SME-approved experimental algorithms, etc., to capture potential and/or actual violations and breaches in the line of fire of equipment and/or other material and, for example, provide an immediate trigger-based alarm to allow of quick mitigation on non-compliance.

As an example, a framework may provide for receiving imagery data from monitoring cameras installed in rigs and/or facilities to determine if working personnel are wearing proper Personal Protective Equipment (PPE), which may vary from location-to-location. As an example, a framework may aim to address one or more PPE compliance problems, which may pose risks leading to accidents due to personnel not wearing the appropriate equipment, or not wearing the equipment properly.

As an example, a framework may utilize one or more machine learning (ML) models to analyze imagery from live cameras and to generate and issue alerts as to one or more violations that may be identified in real-time. As an example, a framework may provide one or more options as to live feedback in the field (e.g., visual and/or audible siren) as well as, for example, one or more of a local and a remote dashboard, which may show historical alerts and statistics about PPE compliance and non-compliance.

As explained, workers may be present at a wellsite, which may include a well for production of oil and/or gas and/or a borehole that may be in the process of being drilled as part of a well construction project for a well for production of oil and/or gas. In the oil and gas industry, particular types of PPE are involved as may be different based on roles, locations, etc. As such, training of one or more machine learning models may be performed to determine what PPE is associated with what roles, locations, etc. In such an approach, the one or more machine learning models may be tailored, optionally automatically, to a wellsite environment where accuracy as to classifications and/or predictions may be improved. As an example, training may include accessing open-source data as well as O&G data to augment deployment possibilities. While the O&G industry is mentioned, such an approach may be suitable for one or more other industries where PPE may differ based on role and/or location (e.g., at a site, etc.). As an example, features detectable in imagery may include color features. For example, PPE may be color-coded, which may correspond to a level of protection, a type of protection, etc. For example, consider coveralls of different colors, hand protectors of different colors, helmets of different colors, facemasks and/or respirators of different colors, etc.

As an example, a framework may provide for PPE-detection tailored to the O&G industry and generalizable to one or more other domains. As an example, a framework may provide for alerting one or more users in a live (real-time) manner and, for example, generating historical PPE compliance across fields and/or clients.

As an example, a framework may generate an alert once a non-compliance event occurs, where, for example, alerts may be stored in a database where users may be given the choice to connect a siren and/or other mechanism to alert workers in real-time. As an example, with the alerts database, a framework may generate value by showing HSE non-compliance trends (e.g., monthly, weekly, daily, etc.). As an example, with a siren, a framework may add value by alerting in real-time about dangers to actual workers in the rig, potentially saving one or more workers from harm. As an example, a siren may be coded for different roles, locations, types of PPE, types of PPE violations, etc. As an example, a siren may be combined with one or more messaging techniques such that a siren may act to notify one or more workers to check a mobile device for further information as to a possible or actual PPE violation.

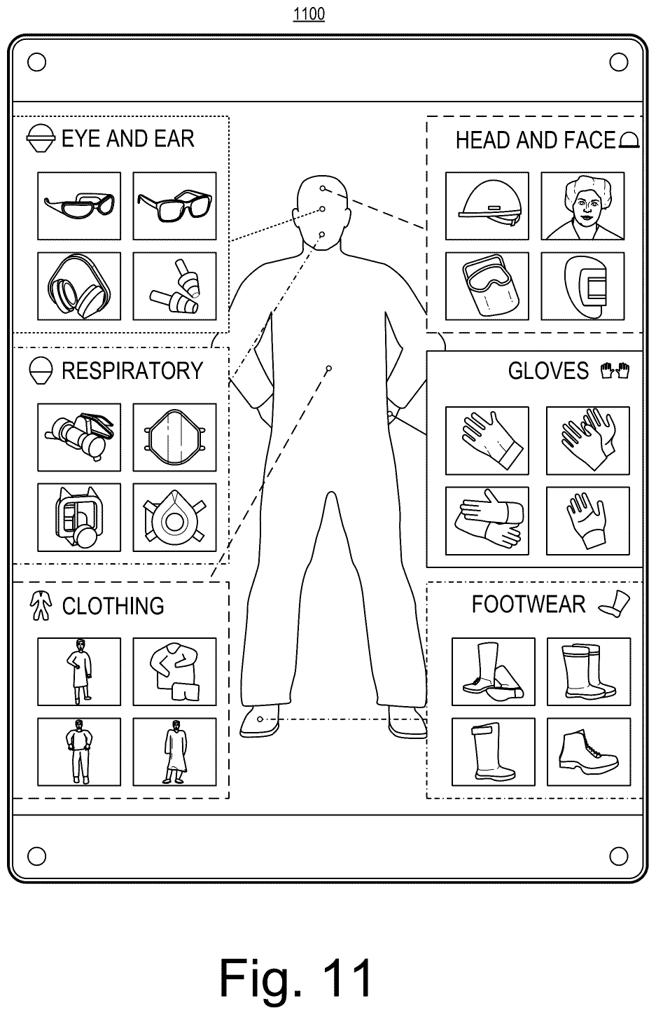

FIG. 11 shows an example of a graphic 1100 that includes various types of PPE, which may include, for example, eye and ear, respiratory, clothing, head and face, gloves, and footwear. In such an example, various different types of PPE within these categories may be detectable via use of one or more ML models. For example, consider one or more deep neural networks that may be trained to detect PPE and to classify PPE, where, for example, a framework may associate PPE with a role and/or a location or roles and/or locations. In such an approach, a master PPE table or other data structure may be utilized to determine whether a violation exists, optionally with a probability or confidence level (e.g., as may be carried over from output of one or more ML models, etc.).

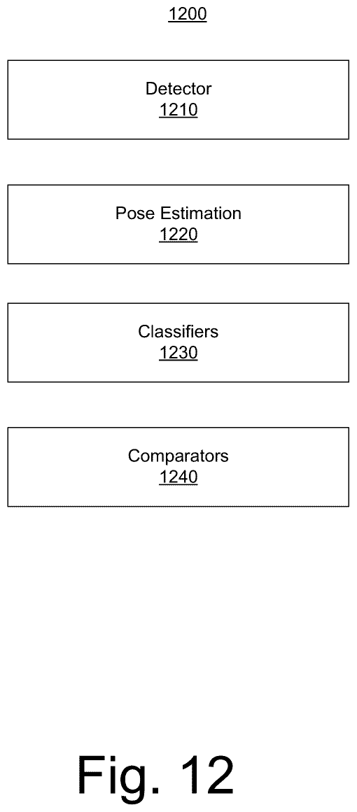

FIG. 12 shows examples of components of an example of a framework 1200 that may include a detector 1210, a pose estimator 1220, classifiers 1230, and comparators 1240. As an example, model-based components may include the detector 1210, the pose estimator 1220 and the classifiers 1230. As an example, a framework may use the detector 1210 to find required body parts (e.g., person, head, torso, hands, feet, face, etc.) and to determine whether PPE is present or not. In such an example, one or more of the classifiers 1230 may be implemented to determine if PPE, whether present or not, is compliant. For example, a framework may use a classifier to classify if a hand image, as may be cropped from an object detection model, has a glove or not (e.g., binary classification). As an example, one or more classifiers may be used for one or more other body parts. As an example, upon detection of presence of PPE, a framework may further classify the PPE, which, as explained, may be based on one or more characteristics (e.g., shape, size, markings, color, etc.). As to the pose estimator 1220, it may be utilized by a framework to provide further insight into a crowded scene. As an example, the detector 1210 and the classifiers 1230 may not be able to distinguish readily between different people in a scene. For example, if multiple hands are detected and persons are close together, it may be more challenging to know for sure which people may be compliant and/or non-compliant. Hence, the pose estimator 1220 may provide additional insight of determining whether each person is non-compliant and/or compliant within a group of individuals. As an example, output of a framework may be in the form of a checklist where the checklist may indicator category compliance and/or non-compliance where, for example, if one category is not properly checked, then an overall non-compliant status may be indicated. As an example, the comparator 1240 may provide for generating output that may be a basis from which to issue one or more instructions (e.g., for provision of PPE, for an alert, etc.).

As explained, a framework may include one or more image capture devices and/or may receive imagery from one or more image capture devices, whether directly and/or indirectly.

As an example, one or more components of a framework may utilize one or more models. For example, consider a model such as a “you only look once” (YOLO) type of model. As an example, consider the YOLOv5 model and/or one or more other types of YOLO models. The YOLOv5 model is a model that builds upon previous YOLO versions and introduced features and improvements to further boost performance and flexibility. YOLOv5 is designed to be fast, accurate and suitable for object detection, instance segmentation, and image classification tasks. A YOLO-based approach may be implemented alone or in combination with one or more other approaches. As an example, a YOLO-based approach may apply a neural network to an image where the neural network divides the image into regions and predicts bounding boxes and probabilities for each region. In such an example, the bounding boxes may be weighted by the predicted probabilities.

In YOLOv1, if the center of an object's bounding box falls into a grid cell, that cell is deemed to contain that object. In such an approach, each grid cell predicts a number of bounding boxes and confidence scores for those boxes. Such confidence scores reflect how confident the model is that the box contains an object and how accurate it determines the box is that it predicts.

As an example, a YOLO model may include a network architecture that includes a number of convolutional layers followed by a number of fully connected layers. As an example, during training, for each cell, if it contains a ground truth bounding box, then only the predicted bounding boxes with the highest intersection over union (IoU) with the ground truth bounding boxes may be utilized for gradient descent.

YOLO models may be implemented in a manner that may provide for real-time object detection and, for example, tracking. For example, one or more YOLO models may be implemented to process video feeds at a relatively high frames-per-second rate. In such an example, movement of objects in a field environment may be identified and tracked. For example, consider tracking of one or more pieces of equipment, which may include, for example, pipe and/or one or more portions of a pipe. Such an approach may be utilized in combination with identification of humans and/or other objects where tracking of equipment and humans and/or other objects may be utilized to provide for issuing warnings, recommendations, control instructions, etc.

As explained, a framework may provide for object detection using computer vision that may identify and locate one or more objects within an image or video. As explained, a framework may provide for image classification that may classify one or more objects within an image or video. As an example, an object detection model may include features of one or more of an R-CNN, a YOLO, etc. As explained, a model may be or include one or more convolutional neural networks (CNNs) to classify objects and/or one or more regressor networks to predict bounding box coordinates for each detected object.

As explained, image classification may utilize an input image and one or more image classification models that may assign one or more portions of the input image to one or more classes of set of classes. As an example, a framework may utilize one or more CNNs, for example, to process pixel data and/or voxel data (e.g., to capture spatial features).

As explained, object localization may be performed, for example, using computer vision to identify a location of an object in imagery data. As an example, a model may extend an image classification model by adding a regression head to predict bounding box coordinates of an object. As an example, a bounding box may be represented by coordinates that define position and, for example, size.

As to optical flow or optic flow, it may be considered a technique that uses a pattern of apparent motion of one or more objects, surfaces, edges, etc., in a visual scene, which may be, for example, caused by relative motion between an observer and a scene. As an example, optical flow may be defined as a distribution of apparent velocities of movement of brightness pattern in an image. As explained, an image may be visual image, a thermal image, a chemical spectrographic image, etc.

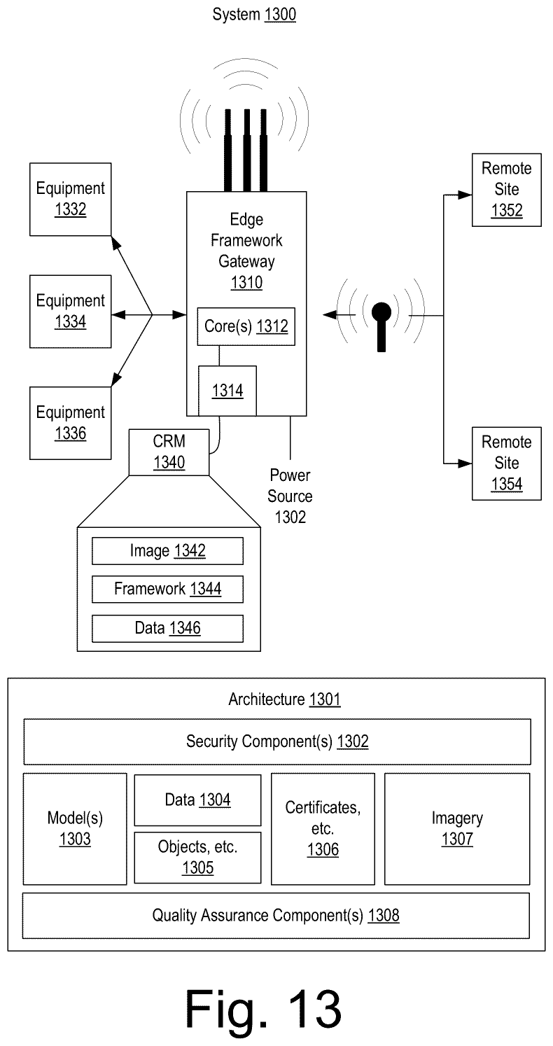

FIG. 13 shows an example of a system 1300 and an example of an architecture 1301. As shown, the architecture 1301 may provide for one or more security components 1302, one or more models 1303 (e.g., machine learning and/or physics-based), data 1304, objects, etc. 1305, certificates, etc. 1306, imagery 1307, and one or more quality assurance components 1308. As an example, a quality assurance component may be associated with one or more types of implementation strategies.

The architecture 1301 may include a result interface where an output result may be a control trigger that may call for an action or actions by a piece or pieces of equipment or by a human or humans.

As shown, the system 1300 may include a power source 1302 (e.g., solar, generator, batter, grid, etc.) that may provide power to an edge framework gateway 1310 that can include one or more computing cores 1312 and one or more media interfaces 1314 that can, for example, receive a computer-readable medium 1340 that may include one or more data structures such as an image 1342, a framework 1344 and data 1346. In such an example, the image 1342 may be an operating system image that may cause one or more of the one or more cores 1312 to establish an operating system environment that is suitable for execution of one or more applications. For example, the framework 1344 may be an application suitable for execution in an established operating system in the edge framework gateway 1310.

In the example of FIG. 13, the edge framework gateway 1310 (“EF”) may include one or more types of interfaces suitable for receipt and/or transmission of information. For example, consider one or more wireless interfaces that may provide for local communications at a site such as to one or more pieces of local equipment 1332, 1334 and 1336 and/or remote communications to one or more remote sites 1352 and 1354.

As an example, the EF 1310 may be installed at a site that is some distance from a city, a town, etc. In such an example, the EF 1310 may be accessible via a satellite communication network.

A communications satellite is an artificial satellite that relays and amplifies radio telecommunication signals via a transponder. A satellite communication network may include one or more communication satellites that may, for example, provide for one or more communication channels. As of 2021, there are about 2,000 communications satellites in Earth orbit, some of which are geostationary above the equator such that a satellite dish antenna of a ground station may be aimed permanently at a satellite rather than tracking the satellite.

High frequency radio waves used for telecommunications links travel by line-of-sight, which may be obstructed by the curve of the Earth. Communications satellites may relay signal around the curve of the Earth allowing communication between widely separated geographical points. Communications satellites may use one or more frequencies (e.g., radio, microwave, etc.), where bands may be regulated and allocated.

Satellite communication tends to be slower and more costly than other types of electronic communication due to factors such as distance, equipment, deployment and maintenance. For wellsites that do not have other forms of communication, satellite communication may be limiting in one or more aspects. For example, where a controller is to operate in real-time or near real-time, a cloud-based approach to control may introduce too much latency.

As shown in the example of FIG. 13, the EF 1310 may be deployed where it may operate locally with one or more pieces of equipment 1332, 1334, 1336, etc., which may be for purposes of control, data acquisition, image capture, issuance of alerts, etc. As an example, the EF 1310 may include switching and/or communication capabilities, for example, for information transmission between equipment, etc.

As desired, from time to time, communication may occur between the EF 1310 and one or more remote sites 1352, 1354, etc., which may be via satellite communication where latency and costs are tolerable. As an example, the CRM 1340 may be a removable drive that may be brought to a site via one or more modes of transport. For example, consider an air drop, a human via helicopter, plane or boat, etc.

As to an air drop, consider dropping an electronic device that may be activated locally once on the ground or while being suspended by a parachute en route to ground. Such an electronic device may communicate via a local communication system such as, for example, a local WiFi, BLUETOOTH, cellular, etc., communication system. In such an example, one or more data structures may be transferred from the electronic device (e.g., as including a CRM) to the EF 1310. Such an approach may provide for local control where one or more humans may or may not be present at the site. As an example, an autonomous and/or human controllable vehicle at a site may help to locate an electronic device and help to download its payload to an EF such as the EF 1310. For example, consider a local drone or land vehicle that may locate an air dropped electronic device and retrieve it and transfer one or more data structures from the electronic device to an EF, directly and/or indirectly. In such an example, the drone or land vehicle may establish communication with and/or read data from the electronic device such that data may be communicated (e.g., transferred to one or more EFs).

As to drones, consider a drone that includes one or more features of one or more of the following types of drones DJI Matrice 210 RTK, DJI Matrice 600 PRO, Elistair Orion Tethered Drone, Freefly ALTA 8, GT Aeronautics GT380, Skydio 2, Sensefly eBee X, Skyfront Perimeter 8, Vantage Robotics Snap, Viper Vantage and Yuneec H920 Plus Tornado. The DJI Matrice 210 RTK may have a takeoff weight of 6.2 g (include battery and max 1.2 kg payload), a maximum airspeed of 13-30 m/s (30-70 mph), a range of 500 m-1 km with standard radio/video though it may be integrated with other systems for further range from base, a flight time of 15-30 minutes (e.g., depending on battery and payload choices, etc.). As an example, a gateway may be a mobile gateway that includes one or more features of a drone and/or that may be a payload of a drone. As an example, one or more drone cameras may be utilized, which may be integral and/or mounted to a drone. As an example, one or more cameras may be at a site, which may be fixed position and/or mobile.

As an example, a framework may provide for control of a drone or drones, which may be utilized for image capture, motion detection, relative motion, issuance of one or more alerts (e.g., to one or more humans), etc. As an example, a drone may be utilized in an environment where the drone may be an observer that can, if called upon, act as an intervener, for example, to cause a human to be notified of non-compliance with respect to PPE, etc.

As shown in FIG. 13, an EF may execute within a gateway such as, for example, an AGORA gateway (e.g., consider one or more processors, memory, etc., which may be deployed as a “box” that may be locally powered and that may communicate locally with other equipment via one or more interfaces). As an example, one or more pieces of equipment may include computational resources that may be akin to those of an AGORA gateway or more or less than those of an AGORA gateway. As an example, an AGORA gateway may be a network device.

As an example, a gateway may include one or more features of an AGORA gateway (e.g., v.202, v.402, etc.) and/or another gateway. For example, consider an INTEL ATOM E3930 or E3950 Dual Core with DRAM and an eMMC and/or SSD. Such a gateway may include a trusted platform module (TPM), which may provide for secure and measured boot support (e.g., via hashes, etc.). A gateway may include one or more interfaces (e.g., Ethernet, RS485/422, RS232, etc.). As to power, a gateway may consume less than about 100 W (e.g., consider less than 10 W or less than 20 W). As an example, a gateway may include an operating system (e.g., consider LINUX DEBIAN LTS). As an example, a gateway may include a cellular interface (e.g., 4G LTE with Global Modem/GPS, etc.). As an example, a gateway may include a WIFI interface (e.g., 802.11 a/b/g/n). As an example, a gateway may be operable using AC 100-240 V, 50/60 Hz or 24 VDC. As to dimensions, consider a gateway that has a protective box with dimensions of approximately 10 in×8 in×4 in.

As an example, a gateway may be part of a drone. For example, consider a mobile gateway that may take off and land where it may land to operatively couple with equipment to thereby provide for control of such equipment. In such an example, the equipment may include a landing pad.

As an example, a drone may be utilized to deliver appropriate PPE to one or more individuals. For example, upon detection of a violation, a drone may be instructed to transport a particular type of PPE to a location for an individual. In such an example, consider a storage of PPE of appropriate sizes where a drone may retrieve PPE of an appropriate size for an individual and carry it to a location of the individual to thereby address a violation in an expeditious manner that may help to reduce risks and reduce non-productive time (NPT) as to field operations. As an example, a drone may be controlled at least in part via image recognition circuitry. For example, consider a drone being controlled based on imagery that identifies an individual without PPE or with improper PPE where the drone may be able to acquire imagery to confirm that the violation still exists and, for example, to confirm the individual and navigate proximate to the individual, if appropriate, for PPE delivery. In such an example, individuals may be aware of such an ability to deliver PPE.

As an example, PPE may include one or more labels, QR-codes, etc., which may be readable by a drone such that a drone may properly identify an individual. For example, consider helmets and/or jackets with QR-codes that a drone may capture using a camera and decipher to appropriately identify an individual for purposes of confirming a violation still exists and/or confirming an individual. In such an approach, drone-based PPE delivery may be improved along conservation of PPE, for example, if a situation has been remedied prior to arrival of the drone. As an example, a drone may by its presence signal to an individual that a PPE violation exists, which may prompt an individual or another individual to rectify the situation.

As an example, a drone may be present at a station that can capture imagery where such a drone may be instructed to fly to a PPE pickup store to pick up PPE and then to an individual or a drop-off location for dropping off the PPE. In such an example, the drone may serve multiple purposes and thereby make more efficient utilization of resources at a site.

An article by Zhang, entitled “Drone-YOLO: An Efficient Neural Network Method for Target Detection in Drone Images”, (Drones, 2023; 7(8):526. https://doi.org/10.3390/drones7080526) is incorporated by reference herein in its entirety. As an example, a drone may be equipped with hardware for implementation of one or more types of models, such as, for example, a YOLO model, etc.

As an example, a gateway may include hardware (e.g. circuitry) that may provide for operation of a drone. As an example, a gateway may be a drone controller and a controller for other equipment where the drone controller may position the gateway (e.g., via drone flight features, etc.) such that the gateway may control the other equipment (e.g., alarms, etc.).

As an example, a gateway may include one or more cameras such that the gateway may record conditions. For example, consider a motion detection camera that may detect the presence of an object. In such an example, an image of the object and/or an analysis (e.g., image recognition) signal thereof may be transmitted (e.g., via a satellite communication link) such that a risk may be assessed at a site that is distant from the gateway. In such an example, the gateway may provide for PPE determinations, such as, for example, PPE compliance and/or non-compliance.

As an example, a gateway may include one or more accelerometers, gyroscopes, etc. As an example, a gateway may include circuitry that may perform seismic sensing that indicates ground movements. Such circuitry may be suitable for detecting and recording equipment movements and/or movement of the gateway itself.

As explained, a gateway may include features that enhance its operation at a remote site that may be distant from a city, a town, etc., such that travel to the site and/or communication with equipment at the site is problematic and/or costly. As explained, a gateway may include an operating system and memory that may store one or more types of applications that may be executable in an operating system environment. Such applications may include one or more security applications, one or more control applications, one or more simulation applications, etc.

As an example, various types of data may be available, for example, consider real-time data from equipment and ad hoc data. In various examples, data from sources connected to a gateway may be real-time, ad hoc data, sporadic data, etc. As an example, lab test data may be available that may be used to fine tune one or more models (e.g., locally, etc.). As an example, data from a framework such as the AVOCET framework may be utilized where results and/or data thereof may be sent to the edge. As an example, one or more types of ad hoc data may be stored in a database and sent to the edge.

As explained, various systems may operate in a local manner, optionally without access to a network such as the Internet. For example, a site may be relatively remote where satellite communication exists as a main mode of communication, which may be costly and/or low bandwidth. In such scenarios, security may resort to local features rather than a remote feature such as a remote authentication server.

An authentication server may provide a network service that applications use to authenticate credentials, which may be or include account names and passwords of users (e.g., human and/or machine). When a client submits a valid credential or credentials to an authentication server, the authentication server may generate a cryptographic ticket that the client may subsequently use to access one or more services.

Authentication may be used as a basis for authorization, which is the determination whether a privilege may be granted to a particular user (e.g., human and/or machine), which may aim to keep information from becoming known to non-participants, and non-repudiation, which is the inability to deny having done something that was authorized to be done based on the authentication.

In the field, a scenario may arise where two or more computational devices are to be paired for communication (e.g., uni- and/or bi-directional transmissions, etc.) via one or more secure channels without having to access the Internet. For example, consider a scenario where a link to the Internet is unavailable, is of too low a bandwidth, is lacking security, is lacking stability, etc. In such a scenario, a local technique may be employed to establish one or more secure channels.

As an example, a framework may implement a hybrid approach that combines machine learning-based model output and physics-based model output in a manner that may consider uncertainty (e.g., in either or both outputs). In such an example, the framework may provide for determining probabilities of one or more risks, which may provide for issuing one or more alerts, control actions, etc.

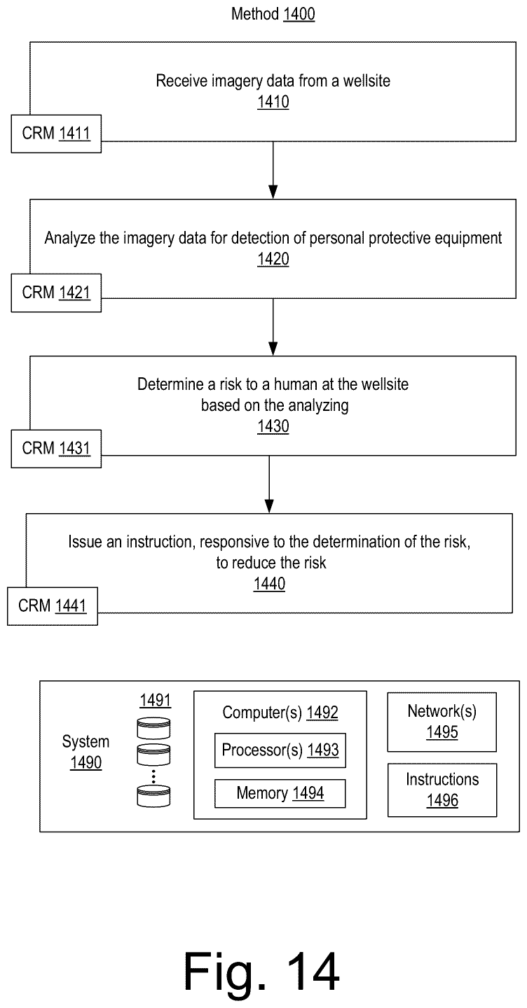

FIG. 14 shows an example of a method 1400 that includes a reception block 1410 for receiving imagery data from a wellsite; an analysis block 1420 for analyzing the imagery data for detection of personal protective equipment; a determination block 1430 for determining a risk to a human at the wellsite based on the analyzing; and, an issuance block 1440 for, responsive to the determining, issuing an instruction to reduce the risk.

FIG. 14 also shows various computer-readable media (CRM) blocks 1411, 1421, 1431 and 1441. Such blocks may include instructions that are executable by one or more processors, which may be one or more processors of a computational framework, a system, a computer, etc. A computer-readable medium may be a computer-readable storage medium that is not a signal, not a carrier wave and that is non-transitory. For example, a computer-readable medium may be a physical memory component that may store information in a digital format.

In the example of FIG. 14, a system 1490 includes one or more information storage devices 1491, one or more computers 1492, one or more networks 1495 and instructions 1496. As to the one or more computers 1492, each computer may include one or more processors (e.g., or processing cores) 1493 and memory 1494 for storing the instructions 1496, for example, executable by at least one of the one or more processors. As an example, a computer may include one or more network interfaces (e.g., wired or wireless), one or more graphics cards, a display interface (e.g., wired or wireless), etc. The system 1490 may be specially configured to perform one or more portions of the method 1400 of FIG. 14.

As to types of machine learning models, consider one or more of a support vector machine (SVM) model, a k-nearest neighbors (KNN) model, an ensemble classifier model, a neural network (NN) model, etc. As an example, a machine learning model may be a deep learning model (e.g., deep Boltzmann machine, deep belief network, convolutional neural network, stacked auto-encoder, etc.), an ensemble model (e.g., random forest, gradient boosting machine, bootstrapped aggregation, AdaBoost, stacked generalization, gradient boosted regression tree, etc.), a neural network model (e.g., radial basis function network, perceptron, back-propagation, Hopfield network, etc.), a regularization model (e.g., ridge regression, least absolute shrinkage and selection operator, elastic net, least angle regression), a rule system model (e.g., cubist, one rule, zero rule, repeated incremental pruning to produce error reduction), a regression model (e.g., linear regression, ordinary least squares regression, stepwise regression, multivariate adaptive regression splines, locally estimated scatterplot smoothing, logistic regression, etc.), a Bayesian model (e.g., naïve Bayes, average on-dependence estimators, Bayesian belief network, Gaussian naïve Bayes, multinomial naïve Bayes, Bayesian network), a decision tree model (e.g., classification and regression tree, iterative dichotomiser 3, C4.5, C5.0, chi-squared automatic interaction detection, decision stump, conditional decision tree, M5), a dimensionality reduction model (e.g., principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.), an instance model (e.g., k-nearest neighbor, learning vector quantization, self-organizing map, locally weighted learning, etc.), a clustering model (e.g., k-means, k-medians, expectation maximization, hierarchical clustering, etc.), etc.

As an example, a machine model, which may be a machine learning model (ML model), may be built using a computational framework with a library, a toolbox, etc., such as, for example, those of the MATLAB framework (MathWorks, Inc., Natick, Massachusetts). The MATLAB framework includes a toolbox that provides supervised and unsupervised machine learning algorithms, including support vector machines (SVMs), boosted and bagged decision trees, k-nearest neighbor (KNN), k-means, k-medoids, hierarchical clustering, Gaussian mixture models, and hidden Markov models. Another MATLAB framework toolbox is the Deep Learning Toolbox (DLT), which provides a framework for designing and implementing deep neural networks with algorithms, pretrained models, and apps. The DLT provides convolutional neural networks (ConvNets, CNNs) and long short-term memory (LSTM) networks to perform classification and regression on image, time-series, and text data. The DLT includes features to build network architectures such as generative adversarial networks (GANs) and Siamese networks using custom training loops, shared weights, and automatic differentiation. The DLT provides for model exchange various other frameworks.

As an example, the TENSORFLOW framework (Google LLC, Mountain View, CA) may be implemented, which is an open-source software library for dataflow programming that includes a symbolic math library, which may be implemented for machine learning applications that may include neural networks. As an example, the CAFFE framework may be implemented, which is a DL framework developed by Berkeley AI Research (BAIR) (University of California, Berkeley, California). As another example, consider the SCIKIT platform (e.g., scikit-learn), which utilizes the PYTHON programming language. As an example, a framework such as the APOLLO AI framework may be utilized (APOLLO.AI GmbH, Germany). As an example, a framework such as the PYTORCH framework may be utilized (Facebook AI Research Lab (FAIR), Facebook, Inc., Menlo Park, California).

As an example, a training method may include various actions that may operate on a dataset to train a ML model. As an example, a dataset may be split into training data and test data where test data may provide for evaluation. A method may include cross-validation of parameters and best parameters, which may be provided for model training.

The TENSORFLOW framework may run on multiple CPUs and GPUs (with optional CUDA (NVIDIA Corp., Santa Clara, California) and SYCL (The Khronos Group Inc., Beaverton, Oregon) extensions for general-purpose computing on graphics processing units (GPUs)). TENSORFLOW is available on 64-bit LINUX, MACOS (Apple Inc., Cupertino, California), WINDOWS (Microsoft Corp., Redmond, Washington), and mobile computing platforms including ANDROID (Google LLC, Mountain View, California) and IOS (Apple Inc.) operating system-based platforms.

TENSORFLOW computations may be expressed as stateful dataflow graphs; noting that the name TENSORFLOW derives from the operations that such neural networks perform on multidimensional data arrays. Such arrays may be referred to as “tensors”.

As an example, a device may utilize TENSORFLOW LITE (TFL) or another type of lightweight framework. For example, consider a gateway that may be in the field (e.g., on-site) and that may utilize the TFL and/or one or more other types of lightweight frameworks. The TFL framework is a set of tools that enables on-device machine learning where models may run on mobile, embedded, and loT devices. The TFL framework is optimized for on-device machine learning, by addressing latency (no round-trip to a server), privacy (no personal data leaves the device), connectivity (Internet connectivity is demanded), size (reduced model and binary size) and power consumption (e.g., efficient inference and a lack of network connections). The TFL framework offers multiple platform support, covering ANDROID and iOS devices, embedded LINUX, and microcontrollers. The TFL framework offers diverse language support includes JAVA, SWIFT, Objective-C, C++, and PYTHON. The TFL framework may provide high performance via hardware acceleration and model optimization.

As an example, a method may include receiving imagery data from a wellsite; analyzing the imagery data for detection personal protective equipment; determining a risk to a human at the wellsite based on the analyzing; and, responsive to the determining, issuing an instruction to reduce the risk. In such an example, the analyzing may include implementing a detector and implementing a classifier. In such an example, the detector may detect a portion of a human body and the classifier may determine whether the portion of the human body has personal protective equipment. In such an example, the classifier may determine a type of personal protectively equipment.

As an example, a method may include determining that determines whether a human is wearing a type of personal protective equipment or is not wearing the type of personal protective equipment.

As an example, a method may include issuing an instruction for instructing a drone to transport a type of personal protective equipment to a human at a wellsite.

As an example, a method may include determining that includes implementing a pose estimator that distinguishes a human from one or more other humans.

As an example, a method may include determining that includes implementing a comparator that compares results of analyzing to proscribed personal protective equipment. In such an example, the proscribed personal protective equipment may depend on one or more of a role of the human and a location of the human at the wellsite. In such an example, analyzing may include detecting one or more of a role of the human and a location of the human.

As an example, analyzing may include detecting more than one type of personal protective equipment. As an example, personal protective equipment (PPE) may include one or more of eye PPE, ear PPE, respiratory PPE, clothing PPE, head PPE, face PPE, hand PPE, and foot PPE (e.g., as different types, which may include sub-types, etc.). As an example, PPE may be categorized where each category may include different variations (e.g., different types, etc.).

As an example, a method may include analyzing and determining where one or more of the analyzing and the determining include implementing at least one machine learning model. For example, at least one machine learning model may include one or more of an object detection model, an object classification model, and an object localization model.

As am example, at least one machine learning model may be or include a you-only-look-once (YOLO) model. In such an example, the YOLO model may perform at least object detection and object classification. As an example, multiple YOLO models may be utilized.

As an example, a system may include a processor; memory accessible by the processor; processor-executable instructions stored in the memory and executable to instruct the system to: receive imagery data from a wellsite; analyze the imagery data for detection of personal protective equipment; make a determination as to a risk to a human at the wellsite based on the analyzing; and, responsive to the determination, issuing an instruction to reduce the risk.

As an example, one or more computer-readable storage media may include processor-executable instructions to instruct a computing system to: receive imagery data from a wellsite; analyze the imagery data for detection of personal protective equipment; make a determination as to a risk to a human at the wellsite based on the analyzing; and, responsive to the determination, issuing an instruction to reduce the risk.

As an example, a method may be implemented in part using computer-readable media (CRM), for example, as a module, a block, etc. that include information such as instructions suitable for execution by one or more processors (or processor cores) to instruct a computing device or system to perform one or more actions. As an example, a single medium may be configured with instructions to allow for, at least in part, performance of various actions of a method. As an example, a computer-readable medium (CRM) may be a computer-readable storage medium (e.g., a non-transitory medium) that is not a carrier wave. As an example, a computer-program product may include instructions suitable for execution by one or more processors (or processor cores) where the instructions may be executed to implement at least a portion of a method or methods.

According to an embodiment, one or more computer-readable media may include computer-executable instructions to instruct a computing system to output information for controlling a process. For example, such instructions may provide for output to sensing process, an injection process, drilling process, an extraction process, an extrusion process, a pumping process, a heating process, etc.

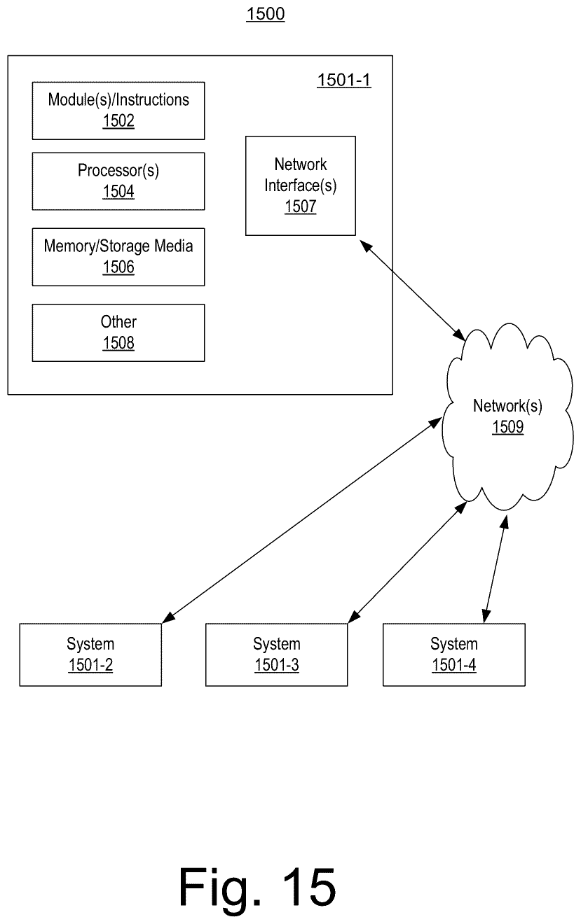

In some embodiments, a method or methods may be executed by a computing system. FIG. 15 shows an example of a system 1500 that may include one or more computing systems 1501-1, 1501-2, 1501-3 and 1501-4, which may be operatively coupled via one or more networks 1509, which may include wired and/or wireless networks.

As an example, a system may include an individual computer system or an arrangement of distributed computer systems. In the example of FIG. 15, the computer system 1501-1 may include one or more modules 1502, which may be or include processor-executable instructions, for example, executable to perform various tasks (e.g., receiving information, requesting information, processing information, simulation, outputting information, etc.).

As an example, a module may be executed independently, or in coordination with, one or more processors 1504, which is (or are) operatively coupled to one or more storage media 1506 (e.g., via wire, wirelessly, etc.). As an example, one or more of the one or more processors 1504 may be operatively coupled to at least one of one or more network interface 1507. In such an example, the computer system 1501-1 may transmit and/or receive information, for example, via the one or more networks 1509 (e.g., consider one or more of the Internet, a private network, a cellular network, a satellite network, etc.). As shown, one or more other components 1508 may be included in the computer system 1501-1.

As an example, the computer system 1501-1 may receive from and/or transmit information to one or more other devices, which may be or include, for example, one or more of the computer systems 1501-2, etc. A device may be located in a physical location that differs from that of the computer system 1501-1. As an example, a location may be, for example, a processing facility location, a data center location (e.g., server farm, etc.), a rig location, a wellsite location, a downhole location, etc.

As an example, a processor may be or include a microprocessor, microcontroller, processor module or subsystem, programmable integrated circuit, programmable gate array, or another control or computing device.

As an example, the storage media 1506 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general-purpose processors or application specific chips (e.g., or chipsets), such as ASICs, FPGAs, PLDs, or other appropriate devices.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that may be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A method comprising:
receiving imagery data from a wellsite;
analyzing the imagery data for detection personal protective equipment;
determining a risk to a human at the wellsite based on the analyzing; and
responsive to the determining, issuing an instruction to reduce the risk.

2. The method of claim 1, wherein the analyzing comprises implementing a detector and implementing a classifier.

3. The method of claim 2, wherein the detector detects a portion of a human body and wherein the classifier determines whether the portion of the human body has personal protective equipment.

4. The method of claim 3, wherein the classifier determines a type of personal protectively equipment.

5. The method of claim 1, wherein the determining determines whether the human is wearing a type of personal protective equipment or is not wearing the type of personal protective equipment.

6. The method of claim 1, wherein the issuing comprises instructing a drone to transport a type of personal protective equipment to the human at the wellsite.

7. The method of claim 1, wherein the determining comprises implementing a pose estimator that distinguishes the human from one or more other humans.

8. The method of claim 1, wherein the determining comprises implementing a comparator that compares results of the analyzing to proscribed personal protective equipment.

9. The method of claim 8, wherein the proscribed personal protective equipment depends on one or more of a role of the human and a location of the human at the wellsite.

10. The method of claim 9, wherein the analyzing comprises detecting one or more of the role of the human and the location of the human.

11. The method of claim 1, wherein the analyzing comprises detecting more than one type of personal protective equipment.

12. The method of claim 1, wherein the personal protective equipment (PPE) comprises one or more of eye PPE, ear PPE, respiratory PPE, clothing PPE, head PPE, face PPE, hand PPE, and foot PPE.

13. The method of claim 1, wherein one or more of the analyzing and the determining comprise implementing at least one machine learning model.

14. The method of claim 13, wherein the at least one machine learning model comprises an object detection model.

15. The method of claim 13, wherein the at least one machine learning model comprises an object classification model.

16. The method of claim 13, wherein the at least one machine learning model comprises an object localization model.

17. The method of claim 13, wherein the at least one machine learning model comprises a you-only-look-once (YOLO) model.

18. The method of claim 17, wherein the YOLO model performs at least object detection and object classification.

19. A system comprising:
a processor;
memory accessible by the processor;
processor-executable instructions stored in the memory and executable to instruct the system to:
receive imagery data from a wellsite;
analyze the imagery data for detection of personal protective equipment;
make a determination as to a risk to a human at the wellsite based on the analyzing; and
responsive to the determination, issuing an instruction to reduce the risk.

20. One or more computer-readable storage media comprising processor-executable instructions to instruct a computing system to:
receive imagery data from a wellsite;
analyze the imagery data for detection of personal protective equipment;
make a determination as to a risk to a human at the wellsite based on the analyzing; and
responsive to the determination, issuing an instruction to reduce the risk.
